(19) United States
(12) Patent Application Publication
(10) Pub. No.: US 2008/0251345 A1
(43) Pub. Date: Oct. 16, 2008

(54) Integrated lip seal for weld contamination control

(75) Inventors: Derrick Zahner, Dundee, OH (US); David Avins, Burbank, OH (US)

Correspondence Address: Howard M. Ellis;SIMPSON & SIMPSON, PLLC, 5555 Main Street, Williamsville, NY, 14221, US

(73) Assignee: LuK Lamellen und Kupplungsbau Beteiligungs KG, Buhl (DE)

(21) Appl. No.: 12/001,831

(22) Filed: Dec. 13, 2007

Related U.S. Application Data
(60) Provisional application No. 60/876,217, filed on Dec. 21, 2006.

(51) Int. Cl. F16D 23/00; C21D 1/34

(52) U.S. Cl. 192/112; 219/162

(57) ABSTRACT

An integrated lip seal provides a containment system for isolating debris generated in welding an enclosure and preventing contamination of interiors of devices. The closure system is especially useful in preventing aggregate from welding contaminating the interiors of torque converters during the final stages of assembly.

### CROSS REFERENCE TO RELATED APPLICATION

This application claims the benefit of U.S. provisional application No. 60/876,217, filed Dec. 21, 2006.

### FIELD OF THE INVENTION

The present invention relates generally to welding debris isolation systems, and more particularly, to improved methods for welding enclosures that avoid introducing welding aggregate into interior spaces. The invention is especially advantageous for use in connection with sealing torque converters, wherein potentially damaging debris from welding is isolated from entry into the interior of such devices. The systems and methods provide a more economic alternative to time consuming manual flushing of converter interiors, and so called “Select-Fit” methods, for example.

### BACKGROUND OF THE INVENTION

Torque converters are positioned between the engine and transmission case of motorized vehicles. They play an important role by controlling on/off power from the engine to the rest of the drive train. In addition, they provide torque multiplication, dampen engine vibration and assure smooth start-ups and speed changes.

A typical torque converter assembly comprises as principal components, an impeller or pump, a turbine and a stator positioned between the turbine and pump. As a step in the final assembly of torque converters a sealed chamber is formed when the front and back covers are welded together. However, in the process of sealing the front and back covers debris from the welding step has a tendency to enter the interior of the converter as contaminants. Welding aggregate, if allowed to remain in the interior of torque converters for motor vehicles can cause excessive wear on internal components and to transmissions. Consequently, current practices in the final assembly require additional steps for removal of debris, which is time consuming and costly, not only requiring more labor, but also requiring substantial capital investment for adding further floor space for the final assembly steps.

Weld contamination inside torque converters has been difficult to eliminate with current machining tolerances and processes. One method practiced has been to isolate weld contamination while joining two components during the welding process. This requires bottoming two component edges together. The process is commonly referred to as “Select-Fit” (See U.S. Pat. No. 4,867,641) and requires the use of costly shims and added method steps to reduce axial movement. Hence, while Select-Fit may reduce contamination from enclosure welding, the method is not entirely satisfactory.

Accordingly, there is a need for improved, more economic systems and methods for eliminating internal contamination from welding in manufacturing processes, and more particularly, to torque converters having improved features which avoid internal contamination from welding debris, including methods of manufacturing, wherein torque converter assembly and manufacture are performed without additional costly hardware components or without requiring internal flushing of the final assembly after welding.

### BRIEF SUMMARY OF THE INVENTION

It is therefore one principal object of the invention to provide improved methods for joining a plurality of hardware components during welding by the steps of:
(i) providing at least an outer hardware component and an inner hardware component. The hardware components comprise axial overlapping mating surfaces with terminal edges, wherein the terminal edge of the inner component comprises a flange extension curved and/or bent sufficiently so as to engage with a surface of the outer component when the inner component engages with the outer component;
(ii) forming an internal weld cavity with the curved and/or bent flange extension for isolation and containment of welding debris or contaminants by aligning the terminal end of the inner component with the terminal end of the outer component so the outer component overlaps with the mating surface of the inner component, and
(iii) forming a seal for the internal weld cavity for collecting and isolating welding debris by welding the outer and inner components together in an overlapping format.

The method is preferably practiced, wherein the outer hardware component comprises an exterior surface and an interior surface and the curved and/or bent flange extension of the inner hardware component is sufficiently curved to engage with and form an interference fit with the interior surface of the outer component when the inner and outer components are in overlapping engagement. As a further preferred feature, the curved and/or bent flange extension, which may be in the form of a hook-shaped extension, comprises an enlarged terminal lip seal for maximizing weld contamination control. Similarly, the mating surfaces of the inner and outer hardware components are notched to form an indentation on the overlapping surfaces.

It is yet a further principal object of the invention to provide torque converters for motorized vehicles featuring a novel welding debris isolation and containment system, especially for preventing welding debris from contaminating their interiors. The systems include torque converter front and back covers with annular terminal edges for inner and outer overlapping engagement with one another, wherein the inner overlapping edge comprises a curved and/or bent flange extension wherein at least a portion of the extension is in contact with the inner surface of the torque converter front cover making an interference fit with the inner surface to form a pocket or weld cavity for collecting debris from welding of front and back covers of torque converters. While the flange extension may be generally hook-shaped it may be virtually any configuration sufficiently curved and/or bent so as to engage with the outer overlapping edge to form an internal reservoir for containment of welding debris. As with the foregoing embodiment of the invention, the hooked-shaped extension is rounded/curved outwardly sufficiently to provide an interference fit with the interior surface of the outer overlapping edge.

Other optional, but preferred features of the torque converter of the invention may include a bow or hook-shaped extension with an enlarged lip seal at the terminus of the hook for optimal sealing of the weld cavity for maximizing welding debris isolation and interior contamination control.

It is still a further object of the invention to provide a device comprising a welding debris isolation and containment system with at least an outer structural element and an inner structural element. The structural elements comprise parallel overlapping mating surfaces with terminal edges. The terminal edge of the inner structural element comprises a generally hook or bow-shaped extension curved sufficiently outwardly to form a loop and to engage with a surface of the outer structural element when the inner structural element engages with the outer structural element forming a sealed cavity for isolating and containment of debris generated during the step of welding the inner and outer structural elements.

### BRIEF DESCRIPTION OF THE DRAWINGS

The nature and mode of operation of the present invention will now be more fully described in the following detailed description of the invention taken with the accompanying drawing figures, in which:

FIG. 1 is a side sectional elevational view of a torque converter featuring a front cover and back impeller cover having a continuous sealed weld cavity according to the present invention referencing FIG. 2;

FIG. 2 is enlarged fragmented view of the welded joint of FIG. 1 illustrating a sealed weld cavity with isolated welding aggregate contained therein;

FIG. 3 is an enlarged fragmented view of the initial step in forming a joint according to the present invention by engaging overlapping edges of outer and inner components of a device prior to welding;

FIG. 4 is an enlarged fragmented view of the next stage of assembly wherein the outer overlapping structure engages the hook-shaped extension of the inner edge to form an interference fit;

FIG. 5 illustrates the final stage of assembly of components prior to welding;

FIG. 6 is a modified variation of the flange extension of FIG. 5;

FIG. 7 represents still a further embodiment of the flange extension with a generally bow-shaped extension forming a welding debris reservoir, and

FIG. 8 is yet a further alternative embodiment of a flange extension engaging the edge of a torque converter front cover to provide an interference fit.

### DETAILED DESCRIPTION OF THE INVENTION

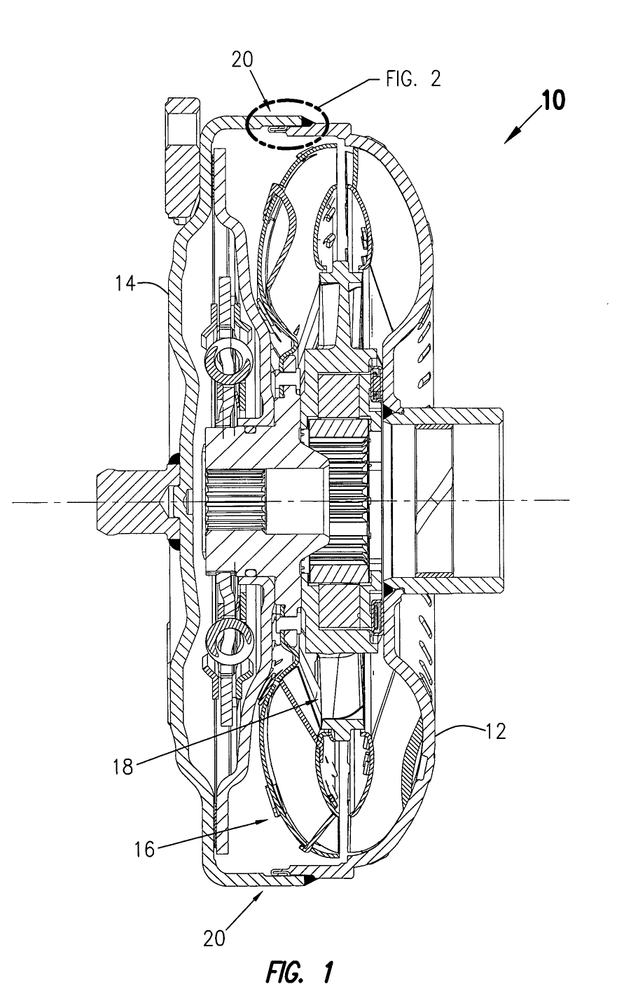

Turning first to FIG. 1, a torque converter 10 is illustrated with four principal components, namely back cover 12 as the pump shell, front cover 14, turbine 16 and stator 18. In torque converter 10, a fluid circuit is created by the pump, sometimes called an impeller, the turbine and the stator, sometimes called a reactor. The fluid circuit allows the engine to continue rotating when a vehicle is stopped, and accelerate the vehicle when desired by the driver.

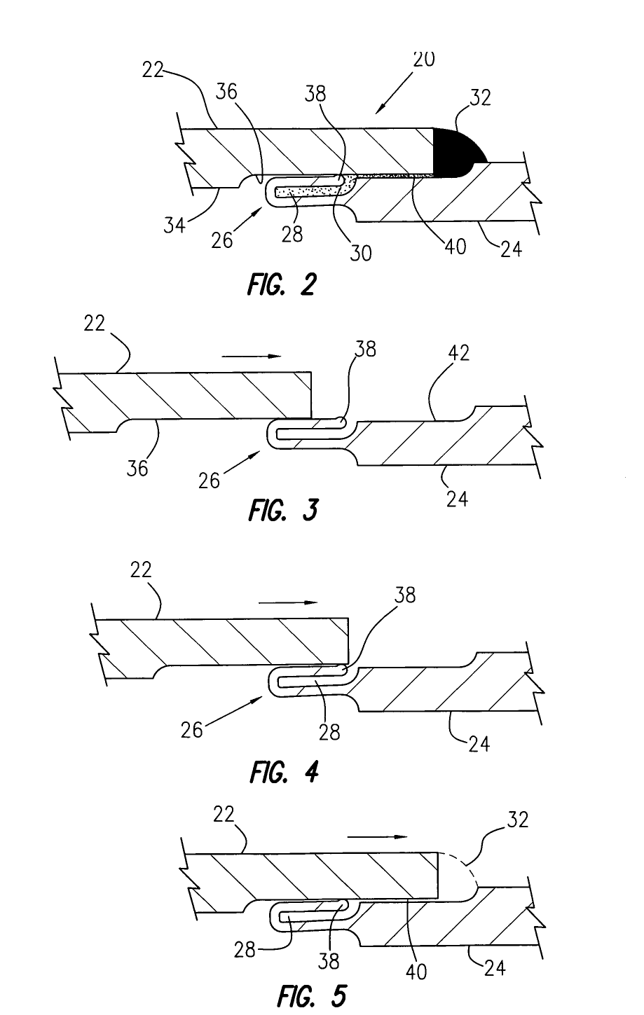

As illustrated, torque converter 10 becomes a sealed chamber when front cover 14 is welded to back cover 12 by means of welded lap joint 20. FIG. 2 is an enlarged partial view of welded lap joint 20 according to the present invention consisting of front cover rim 22 arranged parallel with back cover rim 24. The terminus of rim 24 includes a narrowed extension or flange 26 having a generally U-shape or hook-like configuration when viewed sectionally, as to provide a central sealed weld cavity 28 as a reservoir for collecting and isolating welding aggregate 30 or other debris generated at weld 32. Cavity 28 protects the torque converter by preventing welding aggregate from entering the converter interior during the welding step.

The interior surface 34 of front cover rim 22 preferably comprises a notched or indented surface 36, wherein a somewhat enlarged machined seal 38 at the terminal end of the U-shaped hook 26 engages making an interference fit and seal with the indented interior surface 36. The interference fit generated by the machined seal 38 engaging with indented surface 36 provides a narrow slit 40 as conduit means for transmission of welding debris from weld 32 to weld cavity 28.

FIG. 3 illustrates the initial assembly step of the front and back covers of the torque converter, wherein the indented surface 36 of front cover rim 22 slidably engages with the narrowed U-shaped extension or flange 26 of rim 24 in front of machined seal 38 of back cover 12.

FIGS. 4 and 5 illustrate the engagement of the front cover rim 22 wherein the indented inner surface 36 engages the top-edge of the U-shaped extension 26 with an interference fit with machined seal 38 to form slit 40 as conduit means for transmitting weld aggregate to the weld cavity 28.

The weld cavity 28 incorporating the machined seal 38 does not require additional structural components. Seal 38 contacts the mating axial surface 36 of the front cover rim 22, and is preferably a machined feature of hook 26. A minimum interference of about 0.2 mm radially is designed into this feature. A thin cross-section of material forms the upper edge of the hook 26 is preferred for deflection and to ensure the seal maintains contact with the mating surface 36. A minimum radial load for seal 38 is desired so that at final assembly axial movement of the impeller and cover 12 will not cause damage to either one of these components, nor cause the need for a special press operation.

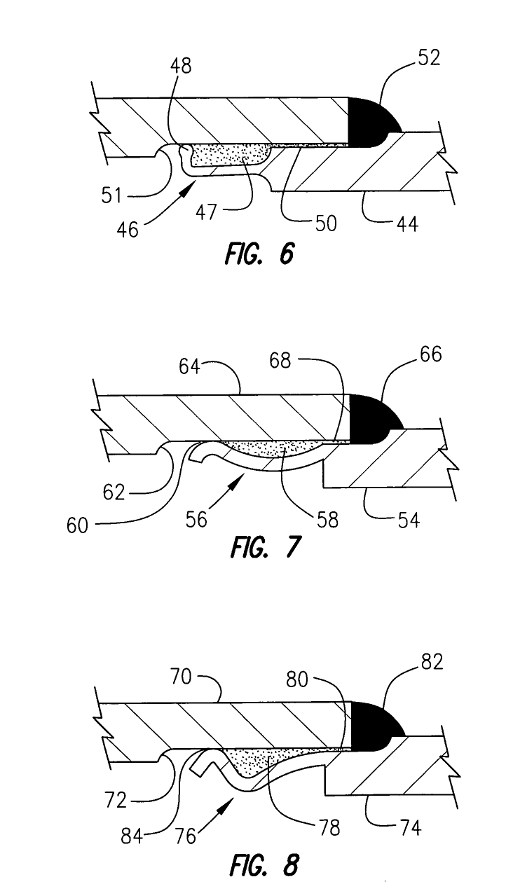

The invention is not limited to the specific embodiments of FIGS. 2-5, but contemplates alternative embodiments, such as those illustrated in FIGS. 6-8. In this regard, back cover rim 44 may include a larger capacity welding debris cavity or reservoir 47 formed from flange extension 46 which comprises a generally rectangular shaped reservoir for collecting welding debris. Cavity 47 is formed from a horizontal arm followed by a vertical extension with a machined seal 48 at the terminus end engaging with indented surface 51. The embodiment of FIG. 6 includes a slit 50 as means for channeling welding debris from weld 52 into welding debris cavity 47.

FIG. 7 represents a further embodiment of the invention wherein the back cover rim 54 includes a generally curved bow shaped flange extension 56 forming a concave shaped welding debris interior 58 with the terminal end portion 60 in pressing engagement with indented surface 62 of the front cover rim 64. Welding debris from weld 66 enters welding cavity/reservoir 58 via slit 68.

A still further embodiment of the lip seal invention for controlling weld contamination is illustrated by FIG. 8, wherein the front cover rim includes an indented inner surface 72. The back cover rim 74 includes flange extension 76 having a modified concave-like depression forming welding debris cavity/reservoir 78 for receiving welding debris via slit 80 from weld 82. A flattened upper edge of terminal portion 84 of flange extension 76 engages with the indented inner surface 72 of the front cover rim to form a closed dependable reservoir for retention of the debris.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

We claim:

1. A method for controlling contamination of hardware interiors during welding, which comprises the steps of:
(i) providing a device comprising at least an outer hardware component and an inner hardware component, said hardware components defining an interior compartment for said device when engaged, said hardware components comprising overlapping mating surfaces with terminal ends, wherein said terminal end of said inner hardware component comprises a flange extension;
(ii) forming a weld cavity for containment of welding debris by bending said flange extension of said inner hardware component so it engages with said outer hardware component when said outer hardware component engages with said inner hardware component to form said cavity, and
(iii) forming a sealed weld cavity for collecting and isolating welding debris by welding said outer and inner hardware components together.

2. The method according to claim 1, wherein said outer hardware component comprises annular exterior and interior surfaces and said flange extension of said inner hardware component is sufficiently curved and/or bent to form an interference fit with said annular interior surface of said outer hardware component when said inner and outer hardware components are engaged in an overlapping arrangement.

3. The method according to claim 2, wherein said curved and/or bent flange comprises a generally hook-shaped extension.

4. The method according to claim 3 wherein said hook-shaped extension comprises an enlarged terminal lip seal.

5. The method according to claim 2, wherein said curved and/or bent flange comprises a generally bow-shaped extension.

6. The method according to claim 2, wherein said overlapping mating surfaces of said inner and outer hardware components are notched.

7. The method according to claim 1, wherein the inner and outer hardware components are structural elements of a torque converter.

8. The method according to claim 7, wherein the outer hardware component is a front cover of the torque converter and the inner hardware component is a back cover or impeller shell of the torque converter.

9. A torque converter comprising a welding debris isolation and containment system, said system comprising torque converter front and back covers with annular terminal ends for inner and outer overlapping engagement with one another, wherein said inner overlapping end comprises a flange extension curved and/or bent sufficiently so as to engage with said outer overlapping end to form a welding debris cavity therein.

10. The torque converter according to claim 9, wherein said curved and/or bent flange extension is generally hook shaped and/or rounded sufficiently to provide an interference fit with the interior surface of said outer overlapping end.

11. The torque converter according to claim 10, wherein the hook-shaped extension comprises an enlarged lip seal for weld contamination control.

12. The torque converter according to claim 10, wherein said annular terminal ends for inner and outer overlapping engagement are notched.

13. The torque converter according to claim 9, wherein said curved and/or bent flange extension is generally bow-shaped.

14. The torque converter according to claim 10, wherein said annular terminal end of said back cover provides the inner end for said overlapping engagement with said terminal end of said front cover.

15. A device comprising a welding debris isolation and containment system, said device comprising at least an outer structural element and an inner structural element, said structural elements comprising axial overlapping mating surfaces with terminal edges, wherein the terminal edge of the inner structural element comprises a generally hook-shaped extension curved and/or bent sufficiently so as to engage with a surface of said outer structural element when the inner structural element engages with said outer structural element.
